(19) United States
(12) Patent Application Publication
(10) Pub. No.: US 2014/0104023 A1
(43) Pub. Date: Apr. 17, 2014

(54) COMPOSITE SOFT MAGNETIC POWDER, COMPOSITE SOFT MAGNETIC POWDER CORE, AND PREPARATION METHOD THEREFOR

(71) Applicants: Bai Yang, Beijing (CN); Ronghai Yu, Beijing (CN); Satoshi Okochi, Miyoshi-shi (JP); Daisuke Okamoto, Toyota-shi (JP)

(72) Inventors: Bai Yang, Beijing (CN); Ronghai Yu, Beijing (CN); Satoshi Okochi, Miyoshi-shi (JP); Daisuke Okamoto, Toyota-shi (JP)

(21) Appl. No.: 13/825,856

(22) PCT Filed: Sep. 23, 2011
(86) PCT No.: PCT/CN11/80085

§ 371 Date: Dec. 23, 2013

(30) Foreign Application Priority Data
Sep. 29, 2010 (CN) 201010297482.3

(51) Int. Cl. H01F 1/26

(52) U.S. Cl. CPC H01F 1/26
USPC 335/297; 148/276; 419/19; 428/407

(57) ABSTRACT

The present invention discloses a composite soft magnetic powder core and a preparation method therefor, which belong to the technical fields of soft magnetic materials and preparation thereof. An Fe/Fe₃O₄ shell layer is generated in situ on surfaces of iron powder particles through a controlled oxidation process, to prepare Fe/Fe₃O₄ composite soft magnetic powder having a uniform structure. The Fe/Fe₃O₄ composite soft magnetic powder is mixed with suitable amount of silicone resin, and prepared into a high-performance Fe/Fe₃O₄ composite soft magnetic powder core by using a powder metallurgy compaction process. Such magnetic powder core has a high density, a high magnetic conductivity, a high magnetic flux density, a low loss, and a high breaking strength, and is useful in a large-power and low-loss application scenario. The present invention has the advantages of being rich in raw material resources, simple in process and environmentally friendly, and being suitable for industrial production.

### FIELD OF THE INVENTION

The present invention belongs to the technical fields of soft magnetic materials and preparation thereof, particularly, relates to a composite soft magnetic powder wherein surface of magnetic particles composing magnetic powder are at least coated with an insulating layer composed of high molecular resin, a preparation method thereof, a composite soft magnetic powder core prepared from the above composite soft magnetic powder and a preparation method therefor.

### BACKGROUND ART

A composite soft magnetic material with high magnetic flux density and low loss has become a research focus in the field of magnetic materials. Such material can be prepared into electromagnetic components in a power-driven system necessary for the development of modern industry, such as rotors of high-speed motor and the like. It has potential application prospects and huge economic benefits in fields like the currently rapid developing high-tech hybrid vehicles and pure electric vehicles, etc. Since the material is required to have high magnetic flux density and low loss in terms of magnetic performance, thus the traditional metal soft magnetic materials and soft magnetic ferrites can hardly meet the requirements of use. Hence, the research and development of new composite soft magnetic material has long been attached great importance.

The preparation process of a composite soft magnetic material often proceeds by coating an insulating layer of organic and inorganic substances on the surface of metal (such as Fe powder) or alloy (such as Fe—Ni, Fe—Co or Fe—Si alloy) magnetic particles, or by forming a composite soft magnetic powder by means of compounding of magnetic particle substrate-high resistivity continuous fibre, followed by preparing into a dense block of soft magnetic material by using a powder metallurgy compaction process. Since the organic insulating layer has a low heat-resistant temperature and poor temperature stability, thus the organics-coated soft magnetic composite material is unsuitable for use under high-temperature conditions. Moreover, the compaction density of the organics-coated powder is relatively low, and the magnetic flux density and the magnetic conductivity of the material are not high. At present, chemical methods are employed to coat metal magnetic particles with inorganics, wherein the coatings are mostly P- or S-containing metal compounds. However, the insulation of the P- or S-coating layer is unsatisfactory, and the P- or S-containing coating liquid may pose a threat of contaminating the environment. The Somaloy-series composite soft magnetic materials developed by Höganäs use phosphate as a coating precursor to form a thickness controllable Fe₃P-coating layer on the surface of Fe powder particle through complex chemical reactions, in that case, the resistivity of the material is greatly increased, and the magnetic loss of the material is reduced under AC conditions. However, the coating process adopted by Höganäs is complicated, and the waste liquor resulting from phosphatizing of iron powder is a potential threat to the environment. Moreover, the Fe₃P-coated layer has a poor insulating property, and the surface of which is easily oxidized.

The research of magnetic material with the magnetic particle-oxide core-shell composite structure originates from its early application in biomedicine. For example, a magnetic particle with the core-shell composite structure may be formed by coating a nano-scale silicon oxide shell layer uniformly on the surface of an ultrafine magnetic particle (Fe₃O₄ having a particle size of less than 10 nm) having superparamagnetism. Such composite particle is not liable to agglomerate, good in dispersibility and strong in corrosion resistance, due to the existence of the oxide shell layer. When a drug is loaded on the surface of the composite magnetic nano particle, transmitted to focal tissues through the targeting effect of the magnetic field, and released at specific site, efficient and low-toxic therapeutic effect can be achieved. For the magnetic particle-oxide core-shell composite structure which is provided with soft magnetic characteristics, the resistivity of the material can be increased by controlling the chemical components of the magnetic particle so that the material has excellent intrinsic magnetic properties, and selection of a suitable oxide as the shell layer. In view of requirements for practical application, a critical technical problem to be solved is to choose a suitable oxide coating layer for complete coating of the surface of magnetic particles. The selection of a suitable oxide coating layer requires, on one hand, increasing the resistivity of the composite magnetic particles and lowering the magnetic loss of the material; and on the other hand, enabling the material to have a high-power performance without overly reducing saturation magnetic flux density and magnetic conductivity.

Moreover, magnetic core which is used for electric motor and the like, has long been prepared by compressing the Fe/Fe₃O₄ composite soft magnetic powder. In order to ensure the electrical insulation between the magnetic particles after compression-molding, the surface of the magnetic particles composing the Fe/Fe₃O₄ composite soft magnetic powder, which is used for the composite soft magnetic powder core, si coated with an insulating layer.

As a method for preparing the Fe/Fe₃O₄ composite soft magnetic powder, for example, a preparation method has been proposed as in JP 2007-194273. To be specific, in such preparation method, firstly iron-based magnetic powder composed of iron-based magnetic particles was prepared. Secondly, the surface layer of the iron-based magnetic particle was oxidized to form an oxide layer of FeO—Fe₂O₃—Fe₃O₄ and the like followed by coating the surface of the oxide layer with a layer composed of insulating substances having insulation higher than that of the oxide layer, heating the oxide layer and the insulating substance layer, to form a metallic compound layer undergoing strengthening treatment. Further, the surface of the metallic compound layer was coated with silicone resin. Particles of thus obtained Fe/Fe₃O₄ composite soft magnetic powder had a metallic compound layer composed of insulating substances, and therefore, the composite soft magnetic powder core prepared therefrom had greater insulation characteristics.

Besides, JP 2009-117471 suggests a preparation method of Fe/Fe₃O₄ composite soft magnetic powder, wherein surface of iron-based magnetic particles is coated with an insulating layer of Al—Si—O-based composite oxide, and the surface of the insulating layer is coated with the of silicone resin.

### DISCLOSURE OF THE INVENTION

However, in the Fe/Fe₃O₄ composite soft magnetic powder prepared in JP 2007-194273, the metal compound layer functions as an insulating layer, thereby enabling a reduction in the eddy current loss of the composite soft magnetic powder core using the powder. However, as the metal compound layer contains FeO, Fe₂O₃, etc., the hysteresis loss of the composite soft magnetic powder core increases and the magnetic flux density decreases, there is the likelihood that the desired magnetic characteristics of the composite soft magnetic powder core can not be achieved.

In view of such situation, it was also conceived of coating the surface of the iron-based magnetic particle only with an insulating layer of high molecular resin, such as silicone resin and the like. However, the wettability and the permeability of the high molecular resin like silicone resin and the like, are not necessarily good for the surface of the iron-based particle. Therefore, without the substrate treatment performed in advance on the particle surface to improve the wettability and permeability, the particle surface cannot be entirely coated with the silicone resin in the course of film formation, or the high molecular resin flows during the powder compaction, so that the insulation at the boundary between particles of the magnetic powder cannot be ensured all the time.

An object of the present invention is to provide Fe/Fe₃O₄ composite soft magnetic powder, and a preparation method therefor, wherein eddy current loss of the composite soft magnetic powder core can be reduced, and reduction in magnetic characteristics of the composite soft magnetic powder core such as magnetic flux density and the like can be inhibited, by maintenance of the insulation characteristics of the composite soft magnetic powder core.

To solve the above problem, as a result of repeatedly intensive study, it happened to the present inventors that in view of the fact that high molecular resin, as a material for the insulating layer, usually contains oxygen element, the wettability and permeability of the surface of the iron-based magnetic particle to the high molecular resin will be improved if the surface of the iron-based magnetic particle also contains oxygen.

As such method, it was also conceived that, for instance, a ferromagnetic or ferrimagnetic oxide is chosen to be coated on the surface of the iron-based magnetic particle. However, even if the oxide is coated as such, if the adhesion strength of the oxide to the particle surface can not be ensured, in the course of powder compaction which needs the wettability and permeability of the high molecular resin, the oxide is likely to detach from the particle surface. Besides, it is not liable to coat the oxide uniformly on the particle surface, and is time-consuming.

Viewing from such perspective, it occurred to the present inventors to oxidize the surface layer of the iron-based magnetic particle itself instead of coating the surface of the iron-based magnetic particle with oxide, and thus a new conception was conceived of: among the iron oxides of FeO, Fe₂O₃, Fe₃O₄, if the ferrimagnetic Fe₃O₄ is subjected to surface layer oxidation, the magnetic characteristics will not be reduced, and the wettability and permeability of the high molecular resin can be improved.

The present invention is one based on the above new conception of the inventors. The preparation method of Fe/Fe₃O₄ composite soft magnetic powder in the first embodiment involved in the present invention is characterized in at least comprising a process of forming an iron oxide layer consisting of Fe₃O₄ by oxidizing surface layer of iron-based magnetic particles composing iron-based magnetic powder; and a process of coating the surface of the iron oxide layer with an insulating layer composed of high molecular resin.

According to this embodiment, there present Fe₃O₄ in the surface of the iron oxide layer, thus the wettability and permeability of the particle surface to the high molecular resin are improved, compared with the composite soft magnetic powder therebefore.

Besides, the surface layer of the iron-based magnetic particle is oxidized to form a continuous iron oxide layer consisting of Fe₃O₄, and thus the iron oxide layer is that of iron from the iron-based magnetic particle. Hence, when the composite soft magnetic powder core is molded, in occurrence of plastic deformation of the particle of the Fe/Fe₃O₄ composite soft magnetic powder, the iron oxide layer does not detach but follows. As a result, even when the composite soft magnetic powder core is molded by compaction and annealed, the high molecular resin at the particle boundary between the iron-based magnetic particles can also be easily maintained. Therefore, the insulation characteristics of the composite soft magnetic powder core can be remained, resulting in a reduction of deterioration of eddy current loss.

Furthermore, the iron oxide layer consisting of Fe₃O₄ is a ferrimagnetic layer. Such iron oxide layer is formed in pursuit of improved wettability and permeability of the high molecular resin, thus it is unnecessary to increase the thickness of the layer with film for the purpose of improving the insulation as before. Thus, the magnetic flux density of the resultant composite soft magnetic powder core is improved compared to the former ones.

In addition, said “powder” in this embodiment refers to a collection of particles. Therefore, the so-called “Fe/Fe₃O₄ composite soft magnetic powder” refers to a collection of particles coated with insulating layer, wherein the surface of the particles is coated with an insulating layer composed of high molecular resin. Moreover, said “insulating layer” in this embodiment refers to a layer for ensuring the electrical insulation between the magnetic powder (particles) after molding. In addition, said “surface layer” in this embodiment refers to a continuous layer formed on the outer side including the surface in the iron-based magnetic particles.

Furthermore, the iron-based magnetic particles are magnetic particles using iron as the main material. If a continuous iron oxide layer consisting of Fe₃O₄ can be formed, other elements such as Ni, Co and the like can be added to Fe. However, in the preparation method involved in this embodiment, pure iron particles can also be used as iron-based magnetic particles.

At present, in case that the Fe/Fe₃O₄ composite soft magnetic powder is prepared by using the pure iron powder composed of pure iron particles, the wettability and permeability of high molecular resin is inadequate for the surface of the pure iron particle, and thus it is necessary to coat with the substrate layer (substrate coating film) such as an insulating layer (Si—Al alkoxide coating film) of Al—Si—O-based composite oxide, etc., as disclosed in JP 2009-117471 to improve the wettability and permeability. However, according to this embodiment, such coating with substrate layer becomes unnecessary due to the formation of the iron oxide layer consisting of Fe₃O₄. In addition, compared with iron alloy powder, pure iron powder is cheap and soft (high formability), and thus can be cheaply and easily prepared into a composite soft magnetic powder core with a high formation density. In addition, compared with the composite soft magnetic powder core prepared by using alloy powder, the magnetic flux density of the composite soft magnetic powder core prepared by using pure iron powder can be improved. Herein the so-called pure iron powder may be iron-based magnetic powder composed of 98% or above of iron and the balance of unavoidable impurities.

Moreover, there is no particular limitation to the high molecular resin, as long as it has electrical insulation, for example, polyimide resin, polyamide resin, aromatic amide resin, silicone resin and the like can be used. These resins are preferred since they contain oxygen element. According to this embodiment, after the molding of the composite soft magnetic powder core, even if it is annealed (heated to 600° C. or more, in case of pure iron as basic material), it is also able to inhibit reliably the eddy current flowing at the particle boundary.

Moreover, the method for forming the iron oxide layer can be conducted via any kind of treatments of gas phase reaction treatment or liquid phase reaction treatment, as long as the desired iron oxide layer as stated above can be formed. For example, chemical conversion treatment may be enumerated as liquid phase reaction treatment. However, in this embodiment, during the formation process of the above iron oxide layer, the oxidation of the surface layer as stated above may be performed by subjecting the above iron-based magnetic particles to heat treatment under an atmosphere of a gas mixture into which oxygen and inert gas are mixed. The iron oxide layer consisting of Fe₃O₄ can be formed in a stable and simple manner by adjusting the concentration of oxygen in the gas mixture.

Further, the oxidation of the surface layer as stated above may be performed under that conditions that the proportion of oxygen in the gas mixture is set in the range of 3% to 30% by volume, the heating temperature in the above heat treatment is set in the range of 100° C. to 500° C., and the duration of the heating treatment is set in the range of 5 min to 90 min.

Via the oxidation of the surface layer performed under such conditions, a continuous iron oxide layer consisting of Fe₃O₄ may be formed uniformly on the surface layer of the iron-based magnetic particles. It is sometimes difficult to form uniformly and continuously iron oxide layer consisting of Fe₃O₄ on the surface layer of the iron-based magnetic particles in case that the proportion of oxygen is less than 3% by volume, the heating temperature is lower than 100° C., or the heating duration is less than 5 min. In addition, there is a risk of formation of FeO, which causes the probability of reducing the magnetic characteristics of the composite soft magnetic powder core.

Furthermore, in case that the proportion of oxygen exceeds 30% by volume, the heating temperature is over 500° C., and the heating duration exceeds 90 min, it is likely to generate not only Fe₃O₄, but also Fe₂O₃ on the surface layer of the iron magnetic particle. Therefore, it may likewise cause the probability of reducing the magnetic characteristics and strength of the composite soft magnetic powder core.

Besides, as the second embodiment of the present invention, Fe/Fe₃O₄ composite soft magnetic powder is also disclosed. The Fe/Fe₃O₄ composite soft magnetic powder involved in the second embodiment is characterized in being composed of particles coated with insulating layer, which are particles wherein an iron oxide layer consisting of Fe₃O₄ is formed on the surface layer of the iron-based magnetic particles, and the surface of the iron oxide layer is coated with an insulating layer composed of high molecular resin.

According to the second embodiment, the wettability and permeability of the iron oxide layer to the high molecular resin are improved, since the surface of the iron oxide layer is Fe₃O₄ oxide. In addition, a continuous iron oxide layer consisting of Fe₃O₄ is formed on the surface layer of the iron-based magnetic particles, thus during the molding of the composite soft magnetic powder core, the iron oxide layer follows the plastic deformation of the basic material in occurrence of plastic deformation of particles of the Fe/Fe₃O₄ composite soft magnetic powder. Therefore, during the molding and annealing of the composite soft magnetic powder core, the high molecular resin can be easily maintained at the particle boundary between the iron-based magnetic particles. Besides, the iron oxide layer consisting of Fe₃O₄ is a layer with ferrimagnetism, and thus has a higher magnetic conductivity relative to the layer of SiO₂, Fe₂O₃, and the like. As a result, the composite soft magnetic powder core prepared from the Fe/Fe₃O₄ composite soft magnetic powder has reduced eddy current loss. In addition, the magnetic flux density of the composite soft magnetic powder core is notably improved compared with the ones therebefore as stated above.

The iron-based magnetic particles hereinabove may be pure iron particles. In that way, a composite soft magnetic powder core with a high formation density can be cheaply and easily prepared, and the magnetic flux density thereof can be improved.

The high molecular resin hereinabove may be silicone resin. In that way, the eddy current at the particle boundary of the composite soft magnetic powder core may be further inhibited by coating with silicone resin.

The composite soft magnetic powder core involved in the second embodiment may be prepared by a method as follows, i.e. molding into a molded body of composite soft magnetic powder core by compression-molding the resultant Fe/Fe₃O₄ composite soft magnetic powder, and annealing the molded body of composite soft magnetic powder core. The wettability and permeability of surface of the iron-based magnetic particles to the high molecular resin are improved, since the particles are coated with the insulating layer of the Fe/Fe₃O₄ composite soft magnetic powder. Therefore, during the compression-molding and annealing, it is easy to maintain high molecular resin at the particle boundary between the iron-based magnetic particles, and a composite soft magnetic powder core with low eddy current loss and high magnetic property can be obtained.

Another object of the present invention is to provide a composite soft magnetic material with application characteristics of high magnetic flux density and low loss, as well as a preparation method therefor. An Fe₃O₄ shell layer is generated in situ on the surface of iron powder particles through a controlled oxidation process, to prepare an Fe/Fe₃O₄ core-shell composite soft magnetic powder having a uniform structure. The Fe/Fe₃O₄ composite soft magnetic powder is mixed with a suitable amount of silicone resin, to prepare an Fe/Fe₃O₄ composite soft magnetic powder core having a high density, a high magnetic conductivity, a high magnetic flux density, a low loss, and a high breaking strength by using a powder compaction molding process.

The technical solution of the present invention is so accomplished:

The third embodiment of the present invention is a composite soft magnetic powder core.

The composite soft magnetic powder core is composed of Fe/Fe₃O₄ composite soft magnetic powder coated with silicon resin on the surface, and is prepared from Fe/Fe₃O₄ core-shell composite soft magnetic powder and silicone resin by compression using powder compaction molding process, wherein the mass fraction of the Fe/Fe₃O₄ core-shell composite soft magnetic powder is 99.2% to 99.8%, the mass fraction of the silicone resin is 0.2% to 0.8%, and the Fe/Fe₃O₄ core-shell composite soft magnetic powder is produced by in situ formation of an Fe/Fe₃O₄ shell layer by a controlled oxidation process on the surface of high-purity iron powder particles with an average particle size of 170 μm and a mass fraction of Fe element of above 99%.

The composite soft magnetic powder core has the application characters of a high magnetic flux density and a low loss.

The composite soft magnetic powder core will attain the most favorable effect in case that an Fe₃O₄ shell layer is generated in situ on the surface of the iron powder particles with an average particle size of 170 μm to form the Fe/Fe₃O₄ core-shell composite soft magnetic powder, and the composite soft magnetic powder core is obtained by compression with silicone resin, and in addition, the mass fraction of the Fe/Fe₃O₄ core-shell composite soft magnetic powder is 99.5%, and the mass fraction of the silicone resin is 0.5%.

The fourth embodiment of the present invention is a preparation method of a composite soft magnetic powder core, characterized in that the method comprises the following steps:

(1) washing iron powder with analytically pure acetone and analytically pure ethanol, followed by drying in a vacuum drying oven, wherein the iron powder used is high-purity iron powder having an average particle size of 170 μm and a mass fraction of Fe element of above 99%.

(2) heating a controllable atmosphere oxidation furnace to 400° C. to 420° C. under low vacuum of 1 Pa to 3 Pa;

(3) placing the washed and dried iron powder from step (1) into the preheated controllable atmosphere oxidation furnace of step (2), meanwhile introducing a gas mixture of argon and high-purity oxygen into the controllable atmosphere oxidation furnace, and after the furnace temperature recovers to 400° C. to 420° C., keeping at the temperature for 40 to 50 min;

(4) withdrawing the heated iron powder in step (3) from the controllable atmosphere oxidation furnace, transferring it promptly to a vacuum furnace at room temperature, cooling it under vacuum condition to room temperature to obtain Fe/Fe₃O₄ composite soft magnetic powder;

(5) mixing the Fe/Fe₃O₄ composite soft magnetic powder prepared in step (4) with silicone resin, wherein the mass fraction of the Fe/Fe₃O₄ composite soft magnetic powder is 99.2% to 99.8%, and the mass fraction of the silicone resin is 0.2% to 0.8%, compressing the mixed material into a dense annular sample by using powder compaction molding process, subjecting the annular sample to annealing treatment under vacuum condition to prepare the composite soft magnetic powder core.

The obtained composite soft magnetic powder core is characterized by a high density, a high magnetic conductivity, a low loss and a high breaking strength, i.e., a composite soft magnetic material having low loss and great power is prepared.

In step (1), the drying temperature can be set in the range of 30° C. to 60° C., the duration may be 20 min to 30 min.

In step (2), the temperature may be raised at a rate of 5 to 30° C./min.

In step (3), the volume fraction of high-purity oxygen in the gas mixture is in the range of 15% to 25%, and the volume fraction of argon is in the range of 75% and 85%. Said argon can be chosen from high purity argon or common argon.

In step (4), the most preferable degree of vacuum chosen for the vacuum condition may be in the range of 3×10⁻³ Pa to 5×10⁻³ Pa.

In step (5), the annular sample may be compressed under a pressure between 1200 MPa and 1800 MPa.

In step (5), the annealing temperature of the annular sample may be set in the range of 500° C. and 700° C., for a duration of 20 min to 40 min.

### Effects of the Invention

An Fe/Fe₃O₄ thin layer is generated in situ on the surface of pure iron powder particles by using a controlled oxidation process in the present invention, to prepare Fe/Fe₃O₄ composite soft magnetic powder, which is mixed with a suitable amount of silicone resin and then compacted to form a high-performance Fe/Fe₃O₄ composite soft magnetic powder core. This novel type of composite magnetic powder core possesses a high magnetic flux density, a low loss and a high breaking strength simultaneously, and is useful in a large-power application scenario. It has potential application prospect and huge economic benefits in fields like the current rapidly developing aerospace, nuclear industry, and civil high-tech like large aircraft and hybrid vehicles, etc. The present invention has the advantages of being rich in raw material resources, simple in process and environmental friendly, and being suitable for industrial production.

Moreover, eddy current loss of the composite soft magnetic powder core may be reduced, and the reduction in magnetic characteristics of the composite soft magnetic powder core such as magnetic flux density and the like may be inhibited, through maintenance of the insulation characteristics of the composite soft magnetic powder core.

### BRIEF DESCRIPTION OF THE DRAWINGS

FIG. 1 is a cross sectional view illustrating the preparation method of the insulating layer coated particle of Fe/Fe₃O₄ composite soft magnetic powder involved in the embodiment of the present invention, wherein a) is a cross sectional view of the iron-based magnetic particle as the raw material, (b) is a cross sectional view of the Fe/Fe₃O₄ core-shell composite soft magnetic powder, and (c) is a cross sectional view of the insulating layer coated particle.

FIG. 2 is a conceptual graph illustrating the surface layer accessories of the insulating layer coated particle shown in FIG. 1 (c).

FIG. 3 is a diagram of the results obtained by analysis on the magnetic powder (Fe₃O₄ powder) in the Example by using a powder X-ray diffraction method (XRD).

FIG. 4 is diagram showing the relationship between the eddy current loss and the magnetic flux density of the composite soft magnetic powder cores involved in the Example and Comparative Examples 1 to 5.

FIG. 5 shows X-ray diffraction (XRD) spectral lines of the iron powder as raw material and of the Fe/Fe₃O₄ core-shell composite soft magnetic powder after generating Fe₃O₄ in situ on surface of the iron powder in Example 1, wherein
spectral line (a) represents the X-ray diffraction spectrum of the iron powder as raw material;
spectral line (b) represents the X-ray diffraction spectrum of the Fe/Fe₃O₄ core-shell composite soft magnetic powder.

FIG. 6 shows hysteresis loops of the iron powder as raw material and of the Fe/Fe₃O₄ core-shell composite soft magnetic powder after generating Fe₃O₄ in situ on surface of the iron powder in Example 1, measured at a maximum external magnetic field of 15 kOe, wherein
loop (a) represents the hysteresis loop of the iron powder as raw material;
loop line (b) represents the hysteresis loop of the Fe/Fe₃O₄ core-shell composite soft magnetic powder.

### EMBODIMENTS OF THE INVENTION

An embodiment of the Fe/Fe₃O₄ composite soft magnetic powder involved in the present invention is illustrated by reference to the figures.

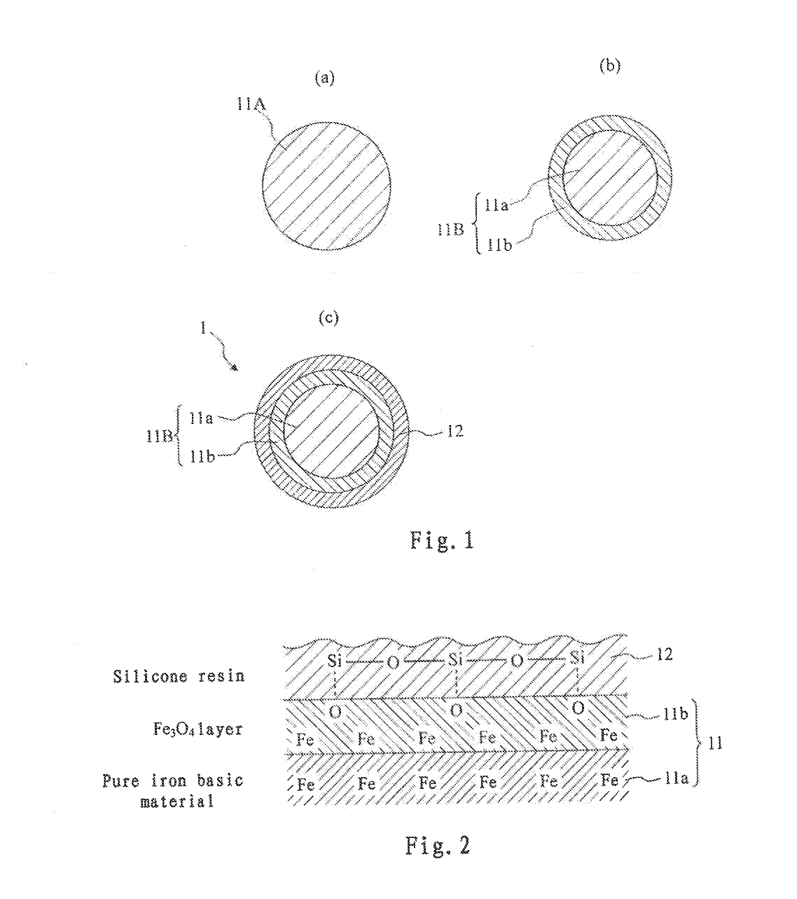

FIG. 1 is a cross sectional view illustrating the preparation method of the insulating layer coated particle of Fe/Fe₃O₄ composite soft magnetic powder involved in the embodiment of the present invention, wherein a) is a cross sectional view of the iron-based magnetic particle as the raw material, (b) is a cross sectional view of the particle with formed Fe₃O₄ layer, (c) is a cross sectional view of the insulating layer coated particle. Firstly, the preparation method for Fe/Fe₃O₄ composite soft magnetic powder is demonstrated as follows. Besides, the Fe/Fe₃O₄ composite soft magnetic powder involved in this embodiment is collection of particles coated with insulating layer 1 (see FIG. 1 (c)).

<The Preparation Method for Fe/Fe₃O₄ Composite Soft Magnetic Powder>

[Preparation of Iron-Based Magnetic Powder]

Firstly, as shown in FIG. 1 (a), particles composed of pure iron (pure iron particle) are prepared, which are produced via gas atomization, as the iron-based magnetic particle 11A composing the iron-based magnetic powder. Here, the iron-based magnetic particle (pure iron particle) 11A is preferably a soft magnetic metal particle with an average particle size of 450 μm or less.

[Formation Process of the Iron Oxide Layer]

Then, the magnetic powder (pure iron powder) composed of the iron-based magnetic particle (pure iron particle) 11A is charged into a heat treatment furnace. A gas mixture with an adjusted mixing ratio of argon to oxygen is introduced into the furnace. The surface layer of the pure iron particle 11A in FIG. 1(a) is oxidized by heating at a prescribed temperature for a prescribed duration, to form an iron oxide layer consisting of Fe₃O₄.

To be specific, a gas mixture with a proportion of oxygen in a range from 3% by volume to 30% by volume is introduced into the heat treatment furnace; the heating temperature for the pure iron powder in the furnace is set in a range from 100° C. to 500° C., and the heating duration for said heat treatment is set in a range from 5 min to 90 min, so as to conduct the oxidation of the surface layer of the pure iron particle 11A composing the pure iron powder.

Through the treatment under such conditions, the Fe/Fe₃O₄ core-shell composite soft magnetic powder 11B is obtained, wherein a continuous iron oxide layer 11b which consisting of Fe₃O₄ is formed uniformly on the surface of the pure iron basic material 11a, as shown in FIG. 1 (b). That is, the Fe/Fe₃O₄ core-shell composite soft magnetic powder 11B is the powder wherein the iron oxide layer 11b consisting of Fe₃O₄ is coated on the surface of the pure ion basic material 11a.

Moreover, under the above conditions, the thickness of the iron oxide layer 11 may range from 5 to 1000 nm. Such a range may ensure the wettablity and permeability of the silicone resin, and ensure the magnetic characteristics of the composite soft magnetic powder core.

In case that the proportion of oxygen is less than 3% by volume, the heating temperature is lower than 100° C., or the heating duration is less than 5 min, it is sometimes difficult to form uniformly and continuously iron oxide layer 11b consisting of Fe₃O₄ on the surface layer of the iron-based magnetic particles 11A. In addition, there is a tendency of forming FeO, which may likewise cause the probability of reducing the magnetic characteristics of the composite soft magnetic powder core.

Furthermore, in case that the proportion of oxygen exceeds 30% by volume, the heating temperature is over 500° C., and the heating duration exceeds 90 min, it is likely to generate not only Fe₃O₄, but also Fe₂O₃ on the surface layer of the iron magnetic particle, which may likewise cause the probability of reducing the magnetic characteristics and strength of the composite soft magnetic powder core.

[Coating Process of The Insulating Layer]

The insulating layer 12 of silicone resin is coated on the surface of the Fe/Fe₃O₄ core-shell composite soft magnetic powder shown in FIG. 1 (b). Firstly, a solution containing silicone resin is prepared in which silicone resin is dissolved in an organic solvent such as alcohol and the like. As the silicon resin, a methyl-based pure silicone resin may be listed. It is preferred to select silicone resins with high contents of Si and O. It is also possible to contain methyl group and ethyl group, etc. in the side chain of the silicone resin.

To be specific, the powder composed of the Fe/Fe₃O₄ core-shell composite soft magnetic powder 11B is impregnated with the silicone resin-containing solution, followed by heating under a temperature of 100° C. or less while removing the organic solvent, and further heated at the temperature ranging from 100° C. to 150° C. Thus, the surface of the iron oxide layer 11b can be coated with the insulating layer 12 composed of the silicone resin.

The obtained insulating layer coated particle 1 composing the Fe/Fe₃O₄ composite soft magnetic powder becomes a particle wherein the insulating layer 12 composed of silicone resin is coated on the surface of the Fe/Fe₃O₄ core-shell composite soft magnetic powder 11B. In addition, in the Fe/Fe₃O₄ core-shell composite soft magnetic powder 11B, the iron oxide layer 11b consisting of Fe₃O₄ is formed on the surface layer of the iron-based magnetic particle 11A (see FIG. 1 (a)). The pure iron basic material 11a for the Fe/Fe₃O₄ core-shell composite soft magnetic powder 11B is composed of pure iron.

Besides, on the insulating layer coated particle 1, as shown in FIG. 2, the iron oxide layer 11b consisting of Fe₃O₄ is formed through oxidation of the surface layer of the iron-based magnetic particle 11A. The silicone resin with a —Si—O—Si— skeleton is positioned on the surface of the iron oxide layer 11b. It is believed that owning to O (oxygen) contained in the two materials, the wettability and permeability of the iron oxide layer 11b to the silicone resin are improved.

<Preparation Method of the Composite Soft Magnetic Powder Core>

The composite soft magnetic powder core is prepared as follows by using the Fe/Fe₃O₄ composite soft magnetic powder as a collection of the insulating layer coated particle 1.

[Molding Process of the Composite Soft Magnetic Powder Core]

Firstly, a higher fatty acid-based lubricant is coated onto the internal surface of a mold, and the Fe/Fe₃O₄ composite soft magnetic powder is filled into the mold, to obtain a molded body of the composite soft magnetic powder core. Here, the mold is heated in order to perform a mold lubrication and warm molding process. In this case, it is preferred to be carried out under the applied pressure of 500 to 2000 MPa. The use of a lubricant prevents the composite soft magnetic powder core from sticking to the mold, enabling molding under even higher pressure, and easy demolding.

During the molding of the composite soft magnetic powder core, in occurrence of plastic deformation of the iron-based magnetic particle of the Fe/Fe₃O₄ composite soft magnetic powder, the iron oxide layer may follow the plastic deformation without detaching, since the iron oxide layer is one of the iron from the iron-based magnetic particle. In addition, as aforementioned, the surface of the iron oxide layer is coated with Fe₃O₄, thus the wettability and permeability of the surface of the iron-based magnetic particle to the silicone resin are improved, compared with the existing composite soft magnetic powder core. As a result, the layer of silicone resin is substantially present uninterruptedly at the particle boundary between the iron-based magnetic particles during the molding of the composite soft magnetic powder core.

[Annealing Process of the Composite Soft Magnetic Powder Core]

The thus obtained molded body of the composite soft magnetic powder core is annealed by heating it under the temperature condition in a range from 550° C. to 1000° C., to give the composite soft magnetic powder core. Thus the residual strain in the iron undergoing plastic deformation is removed, and the hysteresis loss of the composite soft magnetic powder core is reduced.

Moreover, owning to the improved wettability and permeability of the surface of the iron-based magnetic particle to the silicone resin, even though the heated silicone resin is softened during annealing, the silicone resin is still easily maintained between the iron-based magnetic particles. As a result, the insulation characteristics of the composite soft magnetic powder core is improved, which may reduce the eddy current loss.

### Examples

The present invention is demonstrated based on the following examples.

### Example 1

### Preparation of Fe/Fe₃O₄ Composite Soft Magnetic Powder

[Forming Process of the Iron Oxide Layer]

100 g gas atomized powder (pure iron powder) composed of pure iron particles having a particle size in the range of 150 μm to 212 μm (purity: 99%) was prepared as the iron-based magnetic powder. Then, the pure iron powder was placed into a heat treatment furnace, which was immediately vacuumized. A gas mixed by 85% by volume of argon and 15% by volume of oxygen was introduced under such state into the heat treatment furnace until the atmospheric pressure. Thereafter, the heat treatment furnace was heated to 300° C. and kept for 20 min to oxidize the surface layer of the pure iron particles. Thereafter, the powder was withdrawn from the furnace, and cooled to room temperature in a vessel through which argon gas flew, so as to avoid overoxidation of the powder.

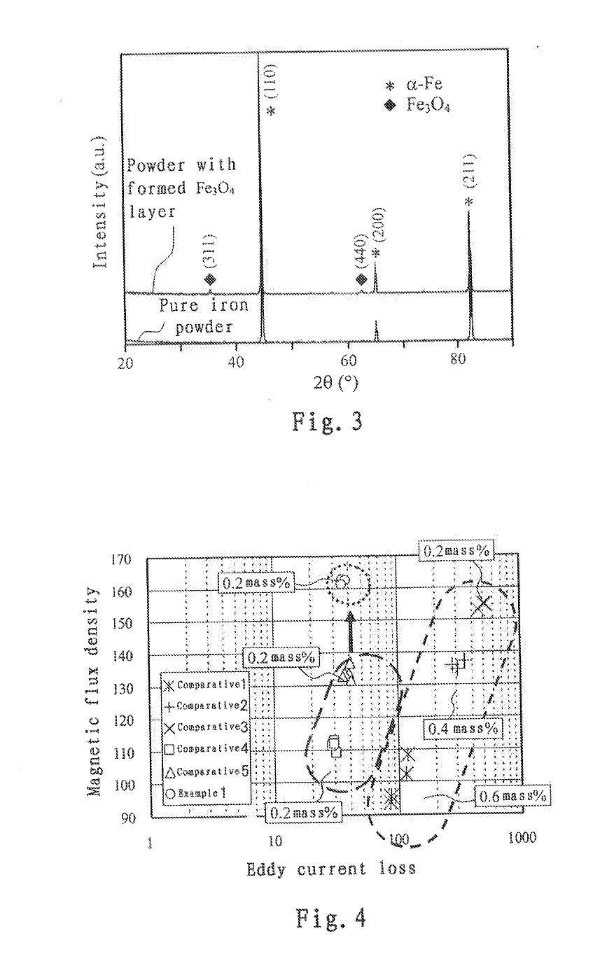

The powder obtained as such (Fe/Fe₃O₄ core-shell composite soft magnetic powder), which was composed of magnetic particles with the formation of an iron oxide layer, was analyzed by using powder X-ray diffraction method (XRD). Analysis results are shown in FIG. 3. Moreover, FIG. 3 also shows analysis results of pure iron powder as reference. As shown in FIG. 3, only Fe₃O₄ was identified as iron oxide from the analysis results, and it was confirmed that the iron oxide layer was one consisting of Fe₃O₄.

[Coating Process of the Insulating Layer]

Silicone resin was mixed to the powder with formed Fe₃O₄ layer to have 0.2 mass % of the silicone resin. To be specific, 0.2 g methyl-based pure silicone resin was dissolved in 50 cc isopropanol (IPA); 100 g previously prepared powder with formed Fe₃O₄ layer was fed into the resultant coating liquid. Then, the IPA solvent was removed while heated under 80° C., followed by heating under 130° C. for 20 min. Thus, the surface of the iron oxide layer was coated with an insulating layer of silicone resin.

<Preparation of Annular Sample (Composite Soft Magnetic Powder Core)>

The Fe/Fe₃O₄ composite soft magnetic powder was charged into a mold. An annular composite soft magnetic powder core with an external diameter of 39 mm, an internal diameter of 30 mm, and a thickness of 5 mm was produced by using mold warm molding process at a mold temperature of 130° C. and a molding pressure of 1600 MPa. In addition, after the molding, heat treatment (annealing) was conducted under nitrogen atmosphere at 600° C. for 30 min.

### Comparative Examples 1 to 3

Composite soft magnetic powder cores (annular samples) were prepared following the same operations as in the example, except that: Comparative examples 1-3 proceeded only with the coating process of the insulating layer, without the formation process of the iron oxide layer. In addition, in the order of Comparative Examples 1 to 3, the mixed amounts of the silicone resin were set at 0.6 mass %, 0.4 mass % and 0.2 mass %, relative to the pure iron powder.

### Comparative Example 4

A composite soft magnetic powder core (annular sample) was prepared following the same operations as in the example, except that: the film forming treatment of a SiO₂ surface film as follows was conducted to substitute the formation process of the iron oxide layer.

To be specific, 100 g pure iron powder, 1000 ml ethanol and 7.5 g oleic acid were metered into a beaker, dispersed by ultrasonic wave under stirring for 1 h. Then, after agitation, 125 ml aqueous ammonia (25 wt %) and 1500 ml ethanol were added and stirred, followed by addition of 50 ml of TEOS in small amounts little by little over 3 h, and continuing to stir. After 3 h, the iron powder was recovered. The recovered iron powder was washed several times with pure water and ethanol, dried at 80° C. for 30 min to form a SiO₂ surface film.

### Comparative Example 5

A composite soft magnetic powder core (annular sample) was prepared following the same operations as in the example, except that: the film forming treatment of a alkoxide surface film as follows was conducted to substitute the formation process of the iron oxide layer.

To be specific, in a glove box under nitrogen atmosphere from which moisture was removed, 100 g pure iron powder, 100 ml dried tetrahydrofuran (THF), 0.6 g aminopropyltriethoxysilane as the Si alkoxide, and 0.6 g aluminum tributoxide as the Al alkoxide were charged into a 500 ml flask. The flask was positioned into a rotary evaporator, and after refluxing for 15 min, it was subjected to reduced pressure distillation to remove THF, and dried under 80° C., 100 Torr. Thereafter, the powder was withdrawn, and dried under nitrogen atmosphere at 190° C. for 2 h. In this way, an alkoxide surface film having a thickness of 30˜100 nm, which was composed of Al—Si—O-based composite oxide, was formed on the surface of the pure iron powder.

<Evaluation of the Annular Samples>

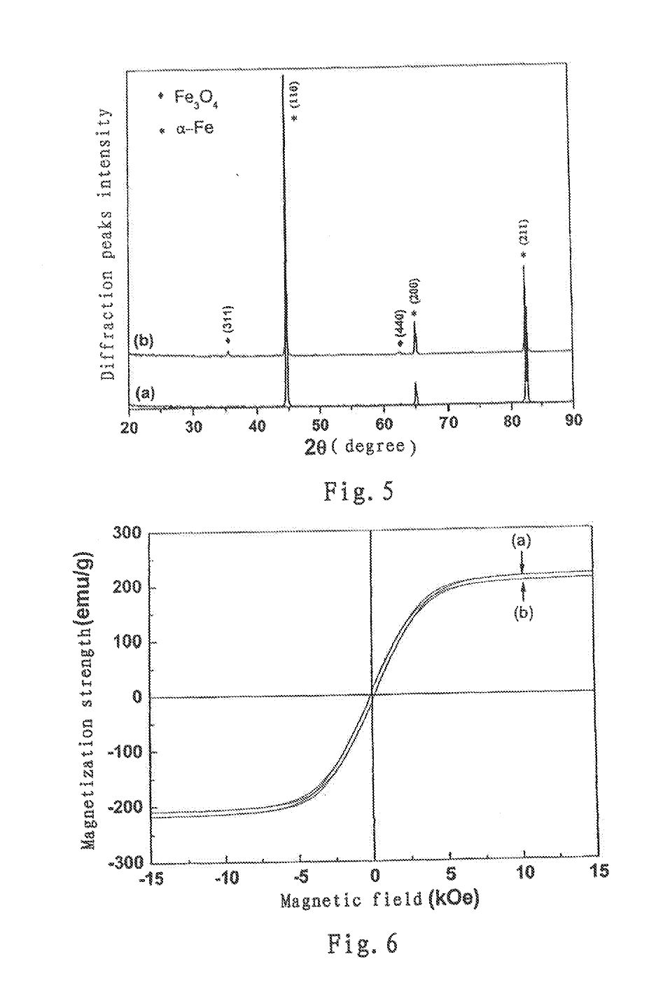

The annular samples were wound with coils. A DC fluxmeter was used for evaluating magnetic flux density, and an AC BH measuring equipment was used for evaluating eddy current loss. Results were shown in FIG. 4. Moreover, the magnetic flux density and the eddy current loss shown in FIG. 4 were values by taking the average value of the magnetic flux density and the eddy current loss in Comparative Example 1 as 100. Besides, the values in mass % as shown in FIG. 4 represent the content proportions of the silicone resin in the example and Comparative examples 1 to 5 relative to pure iron powder.

(Results)

As shown in FIG. 4, the composite soft magnetic powder core of the example has a lower eddy current loss and a higher magnetic flux density in comparison to the ones of Comparative examples 1 to 5. In addition, as can be seen from the results of Comparative examples 1 to 3, the eddy current loss reduced with the increase of the content of the silicone resin, but the magnetic flux density, to the contrary, also reduced. The eddy current loss of the composite soft magnetic powder cores in Comparative examples 4 and 5 were substantially the same as that of the example, whereas the magnetic flux density was lower than that of the example.

(Observation)

The eddy current loss in the example was lower than that in Comparative examples 1 to 3, which was believed to be a result of improved wettability and permeability of silicone resin on the surface of iron-based magnetic particle owing to the formation of iron oxide layer consisting of Fe₃O₄.

The eddy current loss in Comparative example 1, compared with that in the example, was increased regardless of a high content of the silicone resin. As was believed, it was because the silicone resin, which was supposed to present at the particle boundary between iron particles, migrated due to the compression-molding and annealing during the preparation of the composite soft magnetic powder core, so that the iron particles contacted directly with one another; and the silicone resin was not coated entirely when previously coating with the silicone resin.

It was further believed that as learned from the results of the example and Comparative examples 1 to 3, if the iron oxide layer consisting of Fe₃O₄ was set just as in the example, the content of the silicone resin, which was used for ensuring the insulation of the composite soft magnetic powder cores, can be reduced. Thus, it was considered that the magnetic flux density can be improved.

The eddy current losses in the example and in Comparative examples 4 and 5 were substantially the same. Thus, it was believed that even without the cumbersome process of substrate preparation as in Comparative examples 4 and 5, the insulation brought about by the silicone resin could be ensured more reliably, as long as the surface layer of the magnetic particle was oxidized to form an iron oxide layer consisting of Fe₃O₄ as in the example.

Besides, the magnetic flux density of the example was higher than that of Comparative examples 4 and 5. It was believed that since the iron oxide layer consisting of Fe₃O₄ in the example is a ferrimagnetic layer; and since the outmost surface of the pure iron particle changed (is oxidized) to Fe₃O₄ to form a layer consisting of Fe₃O₄, the film thickness itself of the substrate layer (the iron oxide layer consisting of Fe₃O₄) formed on the surface of the pure iron basic material was inhibited to be thin.

### Example 2

A composite soft magnetic powder core having a high magnetic flux density and a low loss was composed of Fe/Fe₃O₄ composite soft magnetic powder coated with silicone resin on the surface, and was prepared into a dense magnetic powder core by a powder compaction process, wherein the mass fraction of the Fe/Fe₃O₄ composite soft magnetic powder was 99.5%, the mass fraction of the silicone resin was 0.5%. As to the Fe/Fe₃O₄ composite soft magnetic powder, Fe₃O₄ is generated in situ on the surface of the high purity iron powder with an average particle size of 170 μm, and a mass fraction of Fe element of over 99%, by a controlled oxidation process.

The preparation method for the composite soft magnetic powder core having a high magnetic flux density and a low loss comprises the following steps:

(1) weighing 25 g high purity iron powders having an average particle size of 170 μm and a mass fraction of Fe element of above 99%, washing with analytically pure acetone and analytically pure ethanol twice, respectively, followed by drying in a vacuum drying oven at 40° C. for 30 min;

(2) heating a controllable atmosphere oxidation furnace to 400° C. under low vacuum of 2 Pa at a heating rate of 10° C./min;

(3) placing the washed and dried iron powder from step (1) into the preheated controllable atmosphere oxidation furnace of step (2), meanwhile introducing a gas mixture of high-purity argon and high-purity oxygen into the controllable atmosphere oxidation furnace, wherein the volume fraction of the high-purity oxygen is 20% and the volume fraction of the high-purity argon is 80%, and after the furnace temperature returns to 400° C., keeping at the temperature for 50 min;

(4) withdrawing the heated iron powder in step (3) from the controllable atmosphere oxidation furnace, transferring it into a vacuum furnace at room temperature promptly, cooling it under vacuum condition of 4×10⁻³ Pa to room temperature, to obtain the Fe/Fe₃O₄ composite soft magnetic powder;

(5) mixing the Fe/Fe₃O₄ composite soft magnetic powder prepared in step (4) with silicone resin, wherein the mass fractions of the Fe/Fe₃O₄ composite soft magnetic powder and the silicone resin were 99.5% and 0.5%, respectively; compressing the mixed powder under a pressure of 1600 MPa into a dense annular sample, subjecting the annular sample to annealing treatment for 30 min at 600° C. under vacuum condition, to ultimately prepare the Fe/Fe₃O₄ composite soft magnetic powder core having a high density, a high magnetic conductivity, a low loss and a high breaking strength, i.e. a composite soft magnetic material having a high magnetic flux density and a low loss.

FIG. 5 is X-ray diffraction (XRD) spectral lines of the raw material iron powder, and of the Fe/Fe₃O₄ core-shell composite soft magnetic powder after in situ formation of Fe₃O₄ on the surface of the iron powder in Example 2. It can be seen that Fe₃O₄ can be formed in situ on the surface of the iron powder through the controlled oxidation process. After the formation of Fe₃O₄ on the surface of the iron powder, the color of the Fe/Fe₃O₄ core-shell composite soft magnetic powder turns abruptly from dark grey to dark blue. The abrupt color change after the formation of the Fe/Fe₃O₄ core-shell composite powder may be utilized to better capture the accuracy of the oxidation process. It is of great guiding significance to the manufacturing process of the materials, and is conducive to promoting a further development and application of materials.

A vibrating sample magnetometer (VSM) was used to measure the hysteresis loop of the Fe/Fe₃O₄ core-shell composite soft magnetic powder prepared in this example at a maximum external magnetic field of 15 kOe. As shown in FIG. 6, the Fe/Fe₃O₄ core-shell composite soft magnetic powder had an intrinsic coercive force which was substantially the same as that of the raw material iron powder, and had a saturation magnetization strength Ms as high as 211.6 emu/g, slightly lower than the corresponding value 217.1 emu/g of the pure iron powder, which demonstrated that the Fe/Fe₃O₄ core-shell composite soft magnetic powder exhibited good intrinsic magnetic properties.

The Fe/Fe₃O₄ core-shell composite soft magnetic powder prepared in this example was mixed with a suitable amount of silicone resin, wherein the mass fractions of the Fe/Fe₃O₄ composite soft magnetic powder and the silicone resin were 99.5% and 0.5%, respectively. The mixed powder was compressed under a pressure of 1600 MPa to prepare a dense annular sample, which was subjected to annealing treatment for 30 min under 600° C. and vacuum condition. The annular sample in this example had a density of 7.5 g/cm³. An AC soft magnetic B-H loop measuring instrument was employed for measuring AC magnetic properties of the annular sample. The Fe/Fe₃O₄ composite magnetic powder core prepared in the example, which has a low magnetic loss, a high magnetic flux density, a high magnetic conductivity and a high breaking strength, is suitable for use in a large-power and low-loss application scenario such as motor rotors.

### Example 3

A composite soft magnetic powder core having a high magnetic flux density and a low loss was composed of Fe/Fe₃O₄ composite soft magnetic powder coated with silicone resin on the surface, and was prepared into a dense magnetic powder core by a powder compaction process, wherein the mass fraction of the Fe/Fe₃O₄ composite soft magnetic powder was 99.8%, the mass fraction of the silicone resin was 0.2%. As to the Fe/Fe₃O₄ composite soft magnetic powder, Fe₃O₄ is generated in situ on the surface of the high purity iron powder with an average particle size of 170 μm, and a mass fraction of Fe element of over 99%, by a controlled oxidation process.

The preparation method for the composite soft magnetic powder core having a high magnetic flux density and a low loss comprises the following steps:

(1) weighing 25 g high purity iron powders having an average particle size of 170 μm and a mass fraction of Fe element of above 99%, washing with analytically pure acetone and analytically pure ethanol for three times, respectively, followed by drying in a vacuum drying oven at 60° C. for 20 min;

(2) heating a controllable atmosphere oxidation furnace to 420° C. under low vacuum of 1 Pa at a heating rate of 5° C./min;

(3) placing the washed and dried iron powder from step (1) into the preheated controllable atmosphere oxidation furnace of step (2), meanwhile introducing a gas mixture of high-purity oxygen and high-purity argon into the controllable atmosphere oxidation furnace, wherein the volume fraction of the high-purity oxygen is 15% and the volume fraction of the high-purity argon is 85%, and after the furnace temperature returns to 420° C., keeping at the temperature for 40 min;

(4) withdrawing the heated iron powder in step (3) from the controllable atmosphere oxidation furnace, transferring it into a vacuum furnace at room temperature promptly, cooling it under vacuum condition of 5×10⁻³ Pa to room temperature, to obtain the Fe/Fe₃O₄ composite soft magnetic powder;

(5) mixing the Fe/Fe₃O₄ composite soft magnetic powder prepared in step (4) with silicone resin, wherein the mass fractions of the Fe/Fe₃O₄ composite soft magnetic powder and the silicone resin were 99.8% and 0.2%, respectively, compressing the mixed powder under a pressure of 1200 MPa into a dense annular sample, subjecting the annular sample to annealing treatment for 40 min at 500° C. under vacuum condition, to ultimately prepare the Fe/Fe₃O₄ composite soft magnetic powder core having a high density, a high magnetic conductivity, a low loss and a high breaking strength, i.e. a composite soft magnetic material having a high magnetic flux density and a low loss.

Compared with the sample in Example 2, as a result of the increase in temperature for the controlled oxidation, the Fe₃O₄ coating layer formed in situ on the surface of the iron powder became thicker, so that the color of the Fe/Fe₃O₄ core-shell composite soft magnetic powder changed to light blue. A vibrating sample magnetometer (VSM) was used to measure the hysteresis loop of the Fe/Fe₃O₄ core-shell composite soft magnetic powder prepared in this example at a maximum external magnetic field of 15 kOe. The results showed that the saturation magnetization strength Ms of the Fe/Fe₃O₄ core-shell composite soft magnetic powder in this example was slightly lower than that of the sample in Example 2, however was still as high as 211.6 emu/g, lower than the corresponding value 217.1 emu/g of the pure iron powder, which demonstrated that the sample of this example exhibited good intrinsic magnetic properties.

The Fe/Fe₃O₄ core-shell composite soft magnetic powder prepared in the example was mixed with a suitable amount of silicone resin, wherein the mass fractions of the Fe/Fe₃O₄ composite soft magnetic powder and the silicone resin were 99.8% and 0.2%, respectively. The mixed powder was compressed under a pressure of 1200 MPa to prepare a dense annular sample, which was subjected to annealing treatment for 40 min under 500° C. and vacuum conditions. The density of the annular sample in this example was 7.6 g/cm³, which was improved relative to Example 2. The density of the annular sample in this example was somewhat improved since the mass fraction of the silicone resin was reduced. An AC soft magnetic B-H loop measuring instrument was employed for measuring AC magnetic properties of the annular sample. The Fe/Fe₃O₄ composite magnetic powder core prepared in this example, which has a low magnetic loss, a high magnetic flux density, a high magnetic conductivity and a high breaking strength, is suitable for use in a large-power and low-loss application scenario such as motor rotors.

### Example 4

A composite soft magnetic powder core having a high magnetic flux density and a low loss was composed of Fe/Fe₃O₄ composite soft magnetic powder coated with silicone resin on the surface, and was prepared into a dense magnetic powder core by a powder compaction process, wherein the mass fraction of the Fe/Fe₃O₄ composite soft magnetic powder was 99.2%, the mass fraction of the silicone resin was 0.8%. As to the Fe/Fe₃O₄ composite soft magnetic powder, Fe₃O₄ is generated in situ on the surface of the high purity iron powder with an average particle size of 170 μm, and a mass fraction of Fe element of over 99%, by a controlled oxidation process.

The preparation method for the composite soft magnetic powder core having a high magnetic flux density and a low loss comprises the following steps:

(1) weighing 25 g high purity iron powders having an average particle size of 170 μm and a mass fraction of Fe element of above 99%, washing with analytically pure acetone and analytically pure ethanol twice, respectively, followed by drying in a vacuum drying oven at 40° C. for 20 min;

(2) heating a controllable atmosphere oxidation furnace to 420° C. under low vacuum of 3 Pa at a heating rate of 15° C./min;

(3) placing the washed and dried iron powder from step (1) into the preheated controllable atmosphere oxidation furnace of step (2), meanwhile introducing a gas mixture of high-purity oxygen and common argon into the controllable atmosphere oxidation furnace, wherein the volume fraction of the high-purity oxygen is 25% and the volume fraction of the common argon is 75%, and after the furnace temperature returns to 420° C., keeping at the temperature for 50 min;

(4) withdrawing the heated iron powder in step (3) from the controllable atmosphere oxidation furnace, transferring it into a vacuum furnace at room temperature promptly, cooling it under vacuum condition of 3×10⁻³ Pa to room temperature, to obtain the Fe/Fe₃O₄ composite soft magnetic powder;

(5) mixing the Fe/Fe₃O₄ composite soft magnetic powder prepared in step (4) with silicone resin, wherein the mass fractions of the Fe/Fe₃O₄ composite soft magnetic powder and the silicone resin were 99.2% and 0.8%, respectively, compressing the mixed powder under a pressure of 1800 MPa into a dense annular sample, subjecting the annular sample to annealing treatment for 20 min at 700° C. under vacuum condition, to ultimately prepare the Fe/Fe₃O₄ composite soft magnetic powder core having a high density, a high magnetic conductivity, a low loss and a high breaking strength, i.e. a composite soft magnetic material having a high magnetic flux density and a low loss.

In this example, common argon was used to replace the high purity argon as the controlled oxidation atmosphere, which likewise prepared Fe/Fe₃O₄ core-shell composite soft magnetic powder similar to those in Examples 2 and 3. The Fe/Fe₃O₄ core-shell composite soft magnetic powder in this example had a saturation magnetization strength Ms as high as 200.6 emu/g, slightly lower than the corresponding value 217.1 emu/g of the pure iron powder, which demonstrated that the sample of this example exhibited good intrinsic magnetic properties. Compared with Example 3, in this example, the Fe₃O₄ coating layer formed in situ on the surface of the iron powder was thickened due to a further prolonged oxidation time, and thus the saturation magnetization value Ms of the Fe/Fe₃O₄ core-shell composite soft magnetic powder in this example was somewhat lowered. The Fe/Fe₃O₄ core-shell composite soft magnetic powder prepared in the example was mixed with a suitable amount of silicone resin, wherein the mass fractions of the Fe/Fe₃O₄ composite soft magnetic powder and the silicone resin were 99.2% and 0.8%, respectively. The mixed powder was compressed under a pressure of 1800 MPa to prepare a dense annular sample, which was subjected to annealing treatment for 20 min under 700° C. and vacuum condition. The density of the annular sample in this example was 7.4 g/cm³. The density of the sample was lowered due to the increase in the mass fraction of the silicone resin and the thickening of the Fe₃O₄ coating layer formed in situ on the surface of the iron powder. An AC soft magnetic B-H loop measuring instrument was employed for measuring AC magnetic properties of the annular sample. The Fe/Fe₃O₄ composite magnetic powder core prepared in this example, which has a low magnetic loss, a high magnetic flux density, a high magnetic conductivity and a high breaking strength, is suitable for use in a large-power and low-loss application scenario such as motor rotors.

The embodiments of the present invention have been described in detail by reference to the figures. However, the composition of the present invention is not confined to such embodiments. Even those design modifications without deviation from the spirit and scope of the present invention shall be included in the present invention.

1. A preparation method for Fe/Fe₃O₄ composite soft magnetic powder, at least comprising:
a process of forming an iron oxide layer consisting of Fe₃O₄ by oxidizing surface layer of iron-based magnetic particles composing iron-based magnetic powder; and
a process of coating the surface of the iron oxide layer with an insulating layer composed of high molecular resin.

2. The preparation method for Fe/Fe₃O₄ composite soft magnetic powder according to claim 1, wherein the iron-based magnetic particles are pure iron particles.

3. The preparation method for Fe/Fe₃O₄ composite soft magnetic powder according to claim 1, wherein silicone resin is used as the high molecular resin.

4. The preparation method for Fe/Fe₃O₄ composite soft magnetic powder according to claim 2, wherein during the process of forming the iron oxide layer, the oxidation of the surface layer is performed by heat treatment of the iron-based magnetic particles under an atmosphere of a gas mixture in which oxygen and inert gas are mixed.

5. The preparation method for Fe/Fe₃O₄ composite soft magnetic powder according to claim 4, wherein during the process of forming the iron oxide layer, the oxidation of the surface layer is performed under the conditions that the proportion of oxygen in the gas mixture is set in the range of 3% to 30% by volume, the heating temperature of the heat treatment is set in the range of 100° C. to 500° C., and the duration of the heat treatment is set in the range of 5 min to 90 min.

6. Fe/Fe₃O₄ composite soft magnetic powder, wherein it is composed of particles coated with insulating layer, the particles coated with insulating layer are particles wherein an iron oxide layer consisting of Fe₃O₄ is formed on the surface layer of iron-based magnetic particles, and an insulating layer which is composed of high molecular resin is coated on the surface of the iron oxide layer.

7. The Fe/Fe₃O₄ composite soft magnetic powder according to claim 6, wherein the iron-based magnetic particles are pure iron particles.

8. The Fe/Fe₃O₄ composite soft magnetic powder according to claim 6, wherein the high molecular resin is silicone resin.

9. A preparation method for a composite soft magnetic powder core, comprising:
a process of molding into a molded body of composite soft magnetic powder core by compression-molding the Fe/Fe₃O₄ composite soft magnetic powder according to claim 6; and
a process of annealing the molded body of composite soft magnetic powder core.

10. A composite soft magnetic powder core, wherein it is prepared by the Fe/Fe₃O₄ composite soft magnetic powder according to claim 6.

11. A composite soft magnetic powder core, wherein the composite soft magnetic powder core is composed of Fe/Fe₃O₄ composite soft magnetic powder coated with silicon resin on the surface, and is prepared from Fe/Fe₃O₄ core-shell composite soft magnetic powder and silicone resin by compression using powder compaction molding process, wherein the mass fraction of the Fe/Fe₃O₄ core-shell composite soft magnetic powder is 99.2% to 99.8%, the mass fraction of the silicone resin is 0.2% to 0.8%, and the Fe/Fe₃O₄ core-shell composite soft magnetic powder is produced by in situ formation of an Fe/Fe₃O₄ shell layer by a controlled oxidation process on the surface of high-purity iron powder particles with an average particle size of 170 μm and a mass fraction of Fe element of above 99%.

12. The composite soft magnetic powder core according to claim 11, wherein the mass fraction of the Fe/Fe₃O₄ core-shell composite soft magnetic powder is 99.5%, and the mass fraction of the silicone resin is 0.5%.

13. A preparation method for a composite soft magnetic powder core,
the method comprising the following steps:
(1) washing iron powder with analytically pure acetone and analytically pure ethanol, followed by drying in a vacuum drying oven, wherein the iron powder used is high-purity iron powder having an average particle size of 170 μm and a mass fraction of Fe element of above 99%;
(2) heating a controllable atmosphere oxidation furnace to 400° C. to 420° C. under low vacuum of 1 Pa to 3 Pa;
(3) placing the washed and dried iron powder from step (1) into the preheated controllable atmosphere oxidation furnace of step (2), meanwhile introducing a gas mixture of argon and high-purity oxygen into the controllable atmosphere oxidation furnace, and after the furnace temperature recovers to 400° C. to 420° C., keeping at the temperature for 40 to 50 min;
(4) withdrawing the heated iron powder in step (3) from the controllable atmosphere oxidation furnace, transferring it promptly to a vacuum furnace at room temperature, cooling it under vacuum condition to room temperature to obtain Fe/Fe₃O₄ composite soft magnetic powder;
(5) mixing the Fe/Fe₃O₄ composite soft magnetic powder prepared in step (4) with silicone resin, wherein the mass fraction of the Fe/Fe₃O₄ composite soft magnetic powder is 99.2% to 99.8%, and the mass fraction of the silicone resin is 0.2% to 0.8%, compressing the mixed material into a dense annular sample by using powder compaction molding process, subjecting the annular sample to annealing treatment under vacuum condition to prepare the composite soft magnetic powder core.

14. The preparation method of a composite soft magnetic powder core according to claim 13, wherein in step (1), the drying temperature is 300° C. to 60° C., and the time is 20 min to 30 min.

15. The preparation method of a composite soft magnetic powder core according to claim 13, wherein in step (2), the temperature is raised at a rate of 5° C./min to 30° C./min.

16. The preparation method for a composite soft magnetic powder core according to claim 13, wherein in step (3), in the gas mixture, the volume fraction of high-purity oxygen is 15% to 25%, and the volume fraction of argon is 75% to 85%.

17. The preparation method of a composite soft magnetic powder core according to claim 13, wherein in step (4), the degree of vacuum chosen for the vacuum condition is 3×10⁻³ Pa to 5×10⁻³ Pa.

18. The preparation method of a composite soft magnetic powder core according to claim 13, wherein in step (5), the annular sample is compressed under a pressure of 1200 MPa to 1800 MPa.

19. The preparation method of a composite soft magnetic powder core according to claim 13, wherein in step (5), the annealing temperature for the annular sample is 500° C. to 700° C., and the annealing time is 20 min to 40 min.

20. The preparation method of a composite soft magnetic powder core according to claim 13, wherein the argon is high-purity argon or common argon.
